(19) United States
(12) Patent Application Publication
(10) Pub. No.: US 2026/0072190 A1
(43) Pub. Date: Mar. 12, 2026

(54) TRANSVERSE WAVE TIME DIFFERENCE PREDICTION METHOD AND APPARATUS

(71) Applicant: PETROCHINA COMPANY LIMITED, Beijing (CN)

(72) Inventors: Lianteng SONG, Beijing (CN); Zhonghua LIU, Beijing (CN); Chaoliu LI, Beijing (CN); Chao YUAN, Beijing (CN); Congqian NING, Beijing (CN)

(73) Assignee: PETROCHINA COMPANY LIMITED, Beijing (CN)

(21) Appl. No.: 19/105,841

(22) PCT Filed: Dec. 14, 2022
(86) PCT No.: PCT/CN2022/138891

§ 371 Date: Feb. 24, 2025

(30) Foreign Application Priority Data
Aug. 26, 2022 (CN) 202211033622.5

(51) Int. Cl. G01V 1/30; G01V 1/50; G06N 3/045

(52) U.S. Cl. CPC G01V 1/307; G01V 1/50; G06N 3/045

(57) ABSTRACT

A shear wave time difference prediction method and apparatus, relating to the technical field of petroleum exploration and development. The method comprises: acquiring well logging sample data as a training data set of a prediction model (101); preprocessing the training data set, performing data screening on the basis of importance analysis, and grouping data on the basis of the kurtosis and the skewness to obtain a processed training data set (102); respectively inputting into a neural network constructed by mixing a CNN and an LSTM the processed training data set for training to obtain a shear wave time difference prediction model (103); acquiring well logging data of a shear wave time difference to be predicted (104); preprocessing the well logging data, and grouping the well logging data on the basis of the kurtosis and the skewness to obtain processed well logging data (105); and respectively using the processed well logging data as an input of the shear wave time difference prediction model to obtain a shear wave time difference (106). The method and the apparatus have the advantages of high processing efficiency, high prediction precision, and strong regional applicability.

### FIELD OF THE INVENTION

The present disclosure relates to the technical field of petroleum exploration and development, in particular to a method for predicting shear wave time difference, an apparatus for predicting shear wave time difference, an electronic device and a machine-readable storage medium.

### BACKGROUND OF THE INVENTION

Shear wave well logging information is one of important parameters for a rock physics analysis, lithology identification, calculation of rock elastic mechanics parameters, reservoir description and fluid identification, which plays an important role in improving reservoir prediction precision. Compressional wave and shear wave well logging information may be obtained by conventional acoustic logging, but an obtained shear wave has poor quality or has missing, which cannot meet production demands. Shear wave data having good quality may be obtained by using a dipole sonic logging device, but acquisition cost is high, acquisition is performed only in a key well or a risk exploratory well, and most of wells are in lack of shear wave well logging information. A well condition, a well logging technology and cost are main factors causing missing, so it is quite important to accurately predict shear wave.

Common methods for predicting the shear wave include an empirical formula method and a rock physics model method. The empirical formula method is to obtain a fitted linear formula by analyzing a compressional wave and shear wave relationship to calculate the shear wave. The method is simple and convenient and can quickly predict the shear wave, but precision of the shear wave predicted by using the empirical formula method is low, and a problem of poor regional applicability exists. The rock physics model method is to calculate the shear wave through models by constructing a rock framework model and a fluid parameter model, the method can accurately predict the shear wave, but the models need many accurate parameters, such as rock mineral constituents, porosity and a pore structure, acquisition of the many parameters is difficult, an accurate rock physics model is not easy to construct, and calculation efficiency is low. To sum up, both the empirical formula method and the rock physics model method have certain limitations, so the present application proposes a predicting method based on a machine learning method.

### SUMMARY OF THE INVENTION

Objectives of embodiments of the present disclosure are to provide a method and apparatus for predicting shear wave time difference. The method and apparatus for predicting the shear wave time difference are used for solving problems in above methods that prediction precision is low, regional applicability is poor, and calculation efficiency is low.

In order to achieve the above objectives, an embodiment of the present disclosure provides a method for predicting shear wave time difference, including:
obtaining well logging sample data as a training data set of a prediction model;
preprocessing the training data set, performing data screening on the basis of importance analysis, and grouping data on the basis of kurtosis and the skewness to obtain a processed training data set;
respectively inputting the processed training data set into a neural network constructed by mixing a CNN and an LSTM for training to obtain shear wave time difference prediction model;
obtaining well logging data of shear wave time difference to be predicted;
preprocessing the well logging data, and grouping the well logging data on the basis of the kurtosis and the skewness to obtain processed well logging data; and
respectively using the processed well logging data as an input of the shear wave time difference prediction model to obtain shear wave time difference.

Preprocessing the training data set, performing data screening on the basis of importance analysis, and grouping data on the basis of the kurtosis and the skewness to obtain the processed training data set includes:
performing data cleansing, data filtering and normalization on the training data set to obtain first training data;
screening out, from the first training data, data with a correlation coefficient between the data and the shear wave time difference being greater than a first preset coefficient value as second training data;
respectively calculating a correlation coefficient between two different types of data in the second training data;
screening out, in a case that two different types of data with the correlation coefficient being greater than a second preset coefficient value exist, any one type of data from the two different types of data, and using the any one type of data and the rest of different types of data with the correlation coefficient being less than or equal to the second preset coefficient value in the second training data as third training data; and
dividing the third training data into at least two groups of well logging data on the basis of a preset kurtosis coefficient and a preset skewness coefficient as the processed training data set.

Optionally, the CNN and the LSTM neural network in the shear wave time difference prediction model are connected through a Dropout layer.

Optionally, the well logging data includes: gamma ray, caliper, spontaneous potential, resistivity, neutron, sonic and density.

Optionally, the correlation coefficient is calculated by using a Pearson's correlation coefficient computational formula.

An embodiment of the present disclosure further provides an apparatus for predicting shear wave time difference, including:
a training data obtaining module, configured to obtain well logging sample data as a training data set of a prediction model;
a first data processing module, configured to preprocess the training data set, perform data screening on the basis of importance analysis, and group data on the basis of the kurtosis and the skewness to obtain a processed training data set;
a model training model, configured to respectively input the processed training data set into a neural network constructed by mixing a CNN and an LSTM for training to obtain shear wave time difference prediction model;
an inputted data obtaining module, configured to obtain well logging data of shear wave time difference to be predicted;
a second data processing module, configured to preprocess the well logging data, and group the well logging data on the basis of kurtosis and the skewness to obtain processed well logging data; and
a result output module, configured to respectively use the processed well logging data as an input of the shear wave time difference prediction model to obtain shear wave time difference.

Wherein the first data processing module is specifically configured to:
perform data cleansing, data filtering and normalization on the training data set to obtain first training data;
screen out, from the first training data, data with a correlation coefficient between the data and the shear wave time difference being greater than a first preset coefficient value as second training data;
respectively calculate a correlation coefficient between two different types of data in the second training data;
screen out, in a case that two different types of data with the correlation coefficient being greater than a second preset coefficient value exist, any one type of data from the two different types of data, and use the any one type of data and the rest of different types of data with the correlation coefficient being less than or equal to the second preset coefficient value in the second training data as third training data; and
divide the third training data into at least two groups of well logging data on the basis of a preset kurtosis coefficient and a preset skewness coefficient as the processed training data set.

Optionally, the CNN and the LSTM neural network in the shear wave time difference prediction model are connected through a Dropout layer.

Optionally, the well logging data includes: gamma ray well logging data, caliper well logging data, self-potential well logging data, resistivity well logging data, neutron well logging data, acoustic well logging data and density well logging data.

Optionally, the correlation coefficient is calculated by using a Pearson's correlation coefficient computational formula.

An embodiment of the present disclosure further provides an electronic device, including a memory, a processor and a computer program stored in the memory and capable of running on the processor, where the processor, when performing the computer program, implements steps of the above method for predicting the shear wave time difference.

In another aspect, the present disclosure provides a machine-readable storage medium, where the machine readable storage medium stores an instruction thereon, and the instruction is used for causing a machine to perform the method for predicting the shear wave time difference.

The technical solution constructs the shear wave time difference prediction model in combination with a neural network constructed by mixing the CNN and the LSTM, data after preprocessing the well logging data of the shear wave time difference to be predicted and grouping the well logging data on the basis of the kurtosis and the skewness is inputted into the shear wave time difference prediction model to obtain the shear wave time difference, calculation is simple, practicability is high, the shear wave time difference can be accurately predicted, and necessary parameters may be provided for the rock physics analysis, lithology identification, rock elastic mechanics parameter calculation, reservoir description, fluid identification and etc.

Other features and advantages of embodiments of the present disclosure will be described in detail in the following detailed description.

### BRIEF DESCRIPTION OF DRAWINGS

Accompanying drawings are for providing further understanding of embodiments of the present disclosure, constitute a part of the specification and together with the following detailed description, serve to explain the embodiments of the present disclosure without constituting the limitation on the embodiments of the present disclosure. In the accompanying drawings:

FIG. 1 is a schematic flowchart of a method for predicting shear wave time difference provided by the present disclosure.

FIG. 2 is a schematic structural diagram of shear wave time difference prediction model provided by the present disclosure.

FIG. 3 is a schematic diagram of positions of different kurtosis provided by the present disclosure.

FIG. 4 is a schematic diagram of positions of different skewness provided by the present disclosure.

FIG. 5 is a schematic structural diagram of an apparatus for predicting shear wave time difference provided by the present disclosure.

FIG. 6 is a schematic diagram of a comparison of shear wave time difference obtained by the present solution provided by the present disclosure and shear wave time difference in the prior art.

Descriptions of reference numerals:

| | |
|---|---|
| 10-training data obtaining module; | 20-first data processing module; |
| 30-model training module; | 40-inputted parameter obtaining |
| | module; |
| 50-second data processing module; | 60-result output module. |

### DETAILED DESCRIPTION OF THE EMBODIMENTS

Specific implementations of the embodiments of the present disclosure are described in detail below with reference to accompanying drawings. It is to be understood that specific implementations described here are merely for describing and explaining the embodiments of the present disclosure instead of limiting the embodiments of the present disclosure.

In the embodiments of the present disclosure, in a case that no contrary description is made, direction words such as “up, down, left and right” usually refer to being based on a direction or a position relationship shown in the accompanying drawings, or refer to a direction or a position relationship of a product in the present disclosure normally placed when in use.

Terms such as “first”, “second” and “third” are only used for distinguishing description instead of being understood as indicating or implying a relative significance.

Besides, words such as “approximately”, “substantially” are intended to explain related contents instead of requiring absolute accuracy, a certain deviation may be allowed. For example: “approximately equal” does not only represent absolute equal, and absolute “equal” is hard to reach during actual production and operation processes, a certain deviation usually exists. Thus, in addition to absolute equal, “approximately equal” further includes the case that the certain deviation exists. Taking this as an example, in other cases, unless otherwise stated particularly, words such as “approximately” and “substantially” have meanings similar to the above. Specific meanings of the above terms in the present disclosure may be understood by those ordinarily skilled in the art according to specific conditions.

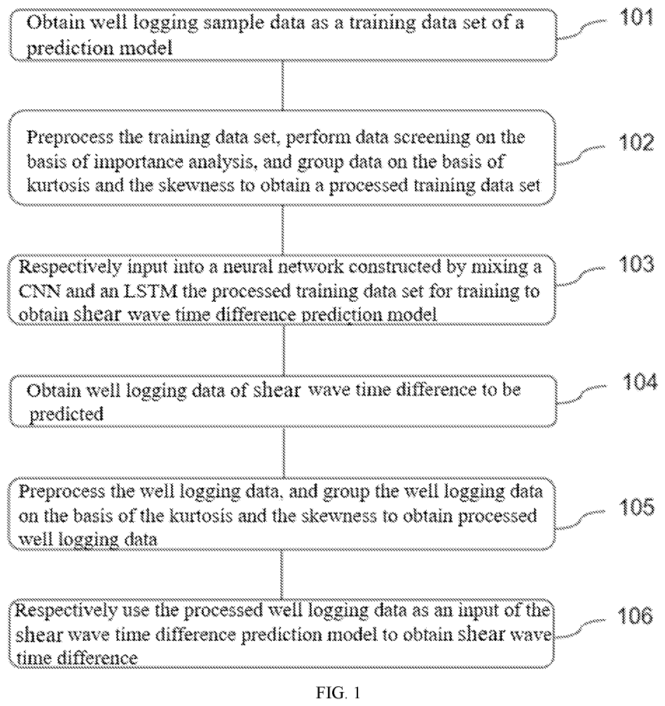

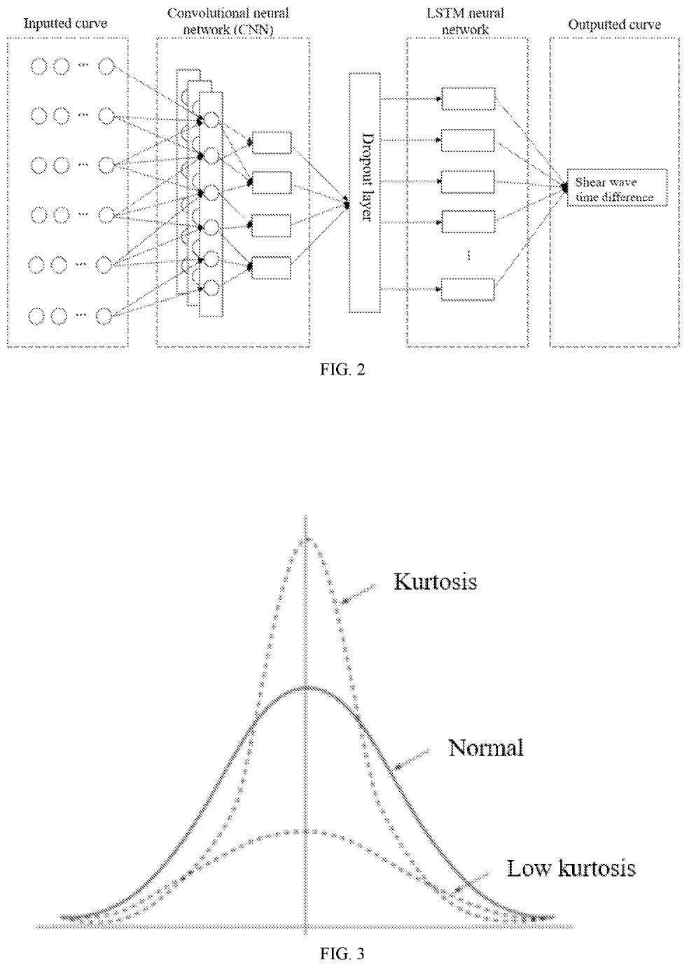

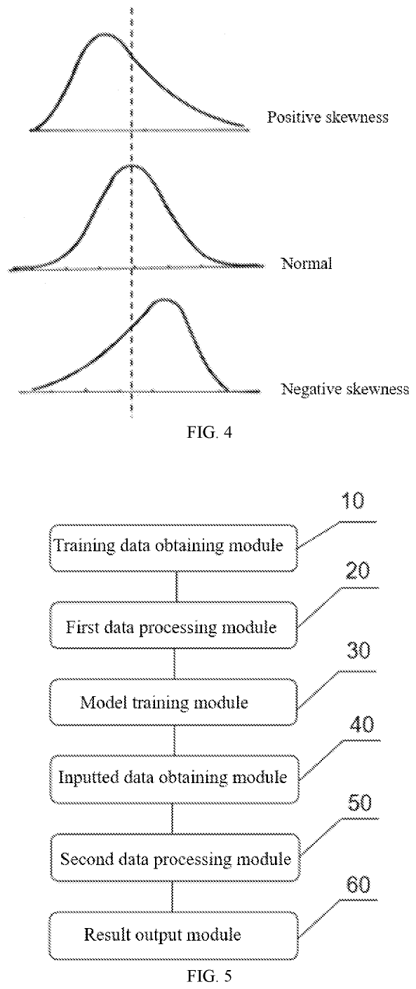

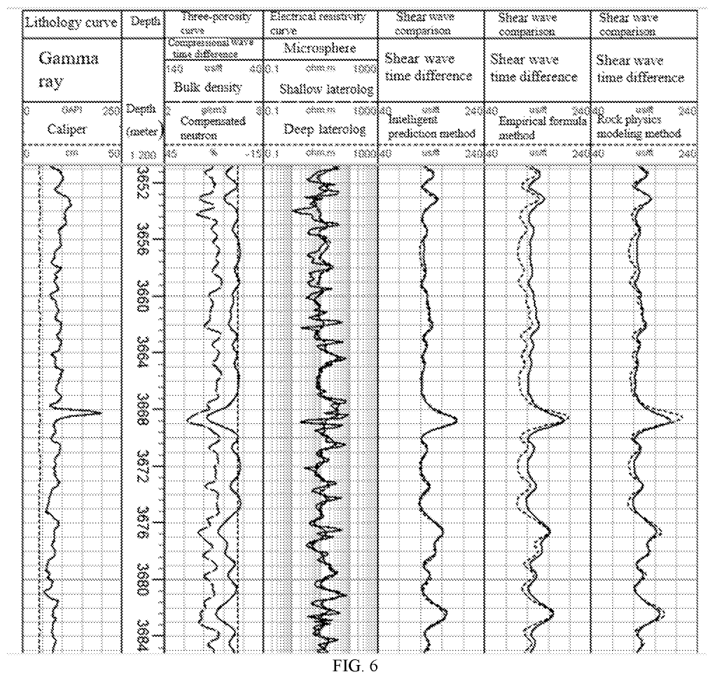

FIG. 1 is a schematic flowchart of a method for predicting shear wave time difference provided by the present disclosure. FIG. 2 is a schematic structural diagram of shear wave time difference prediction model provided by the present disclosure. FIG. 3 is a schematic diagram of positions of different kurtosis provided by the present disclosure. FIG. 4 is a schematic diagram of positions of different skewness provided by the present disclosure. FIG. 5 is a schematic structural diagram of an apparatus for predicting shear wave time difference provided by the present disclosure. FIG. 6 is a schematic diagram of a comparison of shear wave time difference obtained by the present solution provided by the present disclosure and shear wave time difference in the prior art.

As shown in FIG. 1, an embodiment provides a method for predicting shear wave time difference, including:
step 101: obtain well logging sample data as a training data set of a prediction model;
step 102: preprocess the training data set, perform data screening on the basis of importance analysis, and group data on the basis of kurtosis and the skewness to obtain a processed training data set;
step 103: respectively input the processed training data set into a neural network constructed by mixing a CNN and an LSTM for training to obtain shear wave time difference prediction model;
step 104: obtain well logging data of shear wave time difference to be predicted;
step 105: preprocess the well logging data, and group the well logging data on the basis of the kurtosis and the skewness to obtain processed well logging data; and
step 106: respectively use the processed well logging data as an input of the shear wave time difference prediction model to obtain shear wave time difference.

Specifically, in step 101, needing to perform data processing on the well logging sample data includes: preprocessing, performing data screening on the basis of importance analysis, and grouping data on the basis of the kurtosis and the skewness, so as to guarantee that data formats and the like remain uniform for convenience of machine learning, accurate identification of data of the shear wave time difference prediction model is achieved, and accurate prediction of the shear wave time difference is achieved. In step 105, the well logging data is preprocessed, the well logging data is grouped on the basis of the kurtosis and the skewness, at least two groups of processed well logging data are obtained, the at least two groups of processed well logging data are respectively used as the input of the shear wave time difference prediction model, the more accurate shear wave time difference can be obtained, a calculation quantity during the predicting process can be reduced, and efficiency is improved. Besides, in the present implementation, steps of a method for preprocessing the well logging data of the shear wave time difference to be predicted and grouping the well logging data on the basis of the kurtosis and the skewness are similar to the steps of the method for preprocessing the training data set and grouping data on the basis of the kurtosis and the skewness, and are not described in detail here.

Further, the CNN and the LSTM neural network in the shear wave time difference prediction model are connected through a Dropout layer.

Specifically, as shown in FIG. 2, in the present implementation, the shear wave time difference prediction model is obtained by training through the neural network constructed by mixing the CNN and the LSTM. The CNN and the LSTM neural network are connected through the Dropout layer, and the Dropout layer is a structure for reducing neural network overfitting. The CNN, namely, convolutional neural networks (CNN), is one type of neural networks and is one type of feedforward neural network, a weight sharing network structure thereof makes it more similar to a biological neural network, complexity of a network model is lowered, and the number of weights is reduced. The CNN model structure includes three layers of convolution, pooling and full connection, its artificial neuron may respond to a part of surrounding units within coverage, and thus local features of data can be considered. The convolutional layer is to convolute inputted data for the purpose of reducing the number of parameters and connections, so as to greatly reduce the number of iterations and iteration time of the model. The pooling layer, also called a down-sampling layer, is a common component of the convolutional neural network and is mainly used for performing dimensionality reduction on data, removing redundant information, compressing features and simplifying network complexity, so as to facilitate neural network learning. The fully connected layer usually appears on last layers and is used for performing a weighted sum on the foregoing designed features to map distributed local features extracted by the forgoing convolution to a sample label space.

The LSTM neural network, also called a long short-term memory neural network, is a time recurrent neural network, which is designed special for solving a problem of long dependency existing in a general neural network and suitable for processing and predicting important events with very long gap and delay in a time sequence. The LSTM mainly includes a unit state, a forget gate, an input gate and an output gate. The unit state is to circulate information stored by each unit. The forget gate is used for deciding whether to delete some information and mainly processing information transmitted from previous time and information inputted in current time. The input gate is for detecting whether there is an input and determining whether to input the data into a unit state memory. The output gate is for outputting a result based on the unit state, and this result includes the information at the current moment and the previous moment.

Further, the well logging data includes: gamma ray well logging data, caliper well logging data, self-potential well logging data, resistivity well logging data, neutron well logging data, acoustic well logging data and density well logging data.

Further, preprocessing the training data set, performing data screening on the basis of importance analysis, and grouping data on the basis of the kurtosis and the skewness to obtain the processed training data set includes:

performing data cleansing, data filtering and normalization on the training data set to obtain first training data.

Specifically, the training data set includes historical well logging sample data. Data cleansing is to remove an abnormal value in a well logging curve, and the abnormal value may be caused by a well logging environment or may be caused by manual errors. The factor of the well logging environment includes borehole enlargement or very large well deviation, special reservoir, instrument performance constraints, instrument failure and the like. These abnormal values may severely affect neural network model training, and conventional processing methods are for deleting and replacing abnormal data. Data filtering is to perform smoothing processing on data so as to remove noise and mutation data in the data. Normalization processing is to subtract a minimum value from a current value and then divide by a difference between a maximum value and the minimum value for the purpose of limiting data within a certain range, eliminating unfavorable influence caused by singular sample data and improving model convergence rate and precision.

Further, preprocessing the training data set, performing data screening on the basis of importance analysis, and grouping data on the basis of the kurtosis and the skewness to obtain the processed training data set further includes:
screening out, from the first training data, data with a correlation coefficient between the data and the shear wave time difference being greater than a first preset coefficient value as second training data;
respectively calculating a correlation coefficient between two different types of data in the second training data; and
screening out, in a case that two different types of data with the correlation coefficient being greater than a second preset coefficient value exist, any one type of data from the two different types of data, and using the any one type of data and the rest of different types of data with the correlation coefficient being less than or equal to the second preset coefficient value in the second training data as third training data.

Specifically, a magnitude of the correlation coefficient can represent importance between data and a correlation degree between different data, and in general, the greater correlation coefficient indicates that correlation between the data is closer. In the neural network, whether an outputted result of the neural network is good or bad depends greatly on inputted data, providing too many data for a machine learning model may cause reduction of the prediction precision, prolonging of training time and increased possibility of data overfitting, so it is quite necessary for selecting appropriate inputted data. Therefore, in the present implementation, by calculating a correlation coefficient between the inputted data and a prediction result (namely, the shear wave time difference) of the shear wave time difference prediction model, inputted data with the greatest correlation degree with the prediction result can be accurately determined, inputted data most important to the prediction result (namely, the shear wave time difference) of the shear wave time difference prediction model is determined, thus data screening is implemented, the quantity of invalid inputted data is reduced, then a calculation quantity and calculation time of the model are reduced, meanwhile, the prediction efficiency can be improved, and it may be guaranteed that the prediction result of the shear wave time difference prediction model is more accurate.

In the present implementation, by calculating the correlation coefficient between the inputted data and the prediction result (namely, the shear wave time difference) of the shear wave time difference prediction model, data with the correlation coefficient being greater than the first preset coefficient value is screened out as second training data. However, there may be part of data with high similarity in the second training data, using the data with the high similarity as inputted data at the same time may cause repeated use of a variable and data redundancy, so for different types of data in the second training data, a correlation coefficient between any two different types of data is calculated, if the correlation coefficient between the two different types of data is greater than the second preset coefficient value, any one type of data is screened out from the two different types of data which have the correlation coefficient greater than the second preset coefficient value and combined with the rest of different types of data with the correlation coefficient being less than or equal to the second preset coefficient value in the second training data to be used as the third training data.

For example: after screening through the correlation coefficient, the second training data is obtained, a total of five groups of different types of data exist in the second training data (X₁, X₂, X₃, X₄ and X₅), by calculating the correlation coefficient between any two groups of data in the five groups of data, namely, X₁ and X₂, X₁ and X₃, X₁ and X₄, X₁ and X₅, X₂ and X₃, X₂ and X₄, X₂ and X₅, X₃ and X₄, X₃ and X₅, X₄ and X₅, only the correlation coefficient between the data X₂ and X₃ is greater than the second preset coefficient value, so any one type of data (for example, the type of data X₃ is selected) may be selected from the data X₂ and X₃ and used, as the third training data, together with the rest of data (namely, data X₁, X₄ and X₅ with the correlation coefficient being less than or equal to the second preset coefficient value) in the second training data, so the third training data is (X₁, X₃, X₄ and X₅).

For another example: after screening through the correlation coefficient, the second training data is obtained, a total of five groups of different types of data (X₁, X₂, X₃, X₄ and X₅) exist in the second training data, by calculating the correlation coefficient between any two groups of data in the five groups of data, namely, X₁ and X₂, X₁ and X₃, X₁ and X₄, X₁ and X₅, X₂ and X₃, X₂ and X₄, X₂ and X₅, X₃ and X₄, X₃ and X₅, X₄ and X₅, both the correlation coefficient between the data X₂ and X₃ and the correlation coefficient between the data X₄ and X₅ are greater than the second preset coefficient value, any one group of data (for example, the type of data X₂ is selected) selected from the data X₂ and X₃ and any one group of data (for example, the type of data X₅ is selected) selected from X₄ and X₅ are used, as the third training data, together with the rest of data (namely, data with the correlation coefficient being less than or equal to the second preset coefficient value: X₁) in the second training data, so the third training data is (X₁, X₂ and X₅).

Further, preprocessing the training data set, performing data screening on the basis of importance analysis, and grouping data on the basis of the kurtosis and the skewness to obtain the processed training data set further includes:

dividing the third training data into at least two groups of well logging data on the basis of a preset kurtosis coefficient and a preset skewness coefficient as the processed training data set.

Specifically, in the present implementation, the well logging data is grouped through a compressional wave time difference curve peak sharpness and an asymmetry degree of a data distribution, each group of data is used as an input of the model respectively, and the prediction precision of the model can be improved. As shown in FIG. 3 and FIG. 4, the kurtosis, also called peakedness and a kurtosis coefficient, is a characteristic number representing high or low of a peak value of a probability density distribution curve at a mean value, namely, a statistical magnitude indicating a steepness degree of all value distribution patterns in the whole, that is, the kurtosis reflects sharpness of a peak. The skewness, also called skew and a skewness coefficient, is a measurement of statistically calculating a data distribution skewness direction and degree and is a numerical characteristic of statistically calculating the asymmetry degree of the data distribution.

Further, the correlation coefficient is calculated by using a Pearson's correlation coefficient computational formula.

Specifically, the Pearson's correlation coefficient is also called a Pearson product-moment correlation coefficient, which is widely used for measuring a correlation degree between two variables X and Y, and a value of which is between −1 and 1, and the Pearson's correlation coefficient computational formula is:

$${ρ}_{X , Y} = \frac{cov ( X , Y )}{{σ}_{X} {σ}_{Y}}$$

It may be known through the formula that the Pearson's correlation coefficient is dividing a covariance of X and Y by a standard difference of X and then multiplying by a standard difference of Y.

As shown in FIG. 5, the present implementation further provides an apparatus for predicting shear wave time difference, including:
a training data obtaining module 10, configured to obtain well logging sample data as a training data set of a prediction model;
a first data processing module 20, configured to preprocess the training data set, perform data screening on the basis of importance analysis, and group data on the basis of kurtosis and the skewness to obtain a processed training data set;
a model training model 30, configured to respectively input the processed training data set into a neural network constructed by mixing a CNN and an LSTM for training to obtain shear wave time difference prediction model;
an inputted data obtaining module 40, configured to obtain well logging data of shear wave time difference to be predicted;
a second data processing module 50, configured to preprocess the well logging data, and group the well logging data on the basis of the kurtosis and the skewness to obtain processed well logging data; and
a result output module 60, configured to respectively use the processed well logging data as an input of the shear wave time difference prediction model to obtain a shear wave time difference.

The first data processing module 20 is specifically configured to:
perform data cleansing, data filtering and normalization on the training data set to obtain first training data;
screen out, from the first training data, data with a correlation coefficient between the data and the shear wave time difference being greater than a first preset coefficient value as second training data;
respectively calculate a correlation coefficient between two different types of data in the second training data; and
screen out, in a case that two different types of data with the correlation coefficient being greater than a second preset coefficient value exist, any one type of data from the two different types of data, and use the any one type of data and the rest of different types of data with the correlation coefficient being less than or equal to the second preset coefficient value in the second training data as third training data; and
divide the third training data into at least two groups of well logging data on the basis of a preset kurtosis coefficient and a preset skewness coefficient as the processed training data set.

Further, the CNN and the LSTM neural network in the shear wave time difference prediction model are connected through a Dropout layer.

Further, the well logging data includes: gamma ray well logging data, caliper well logging data, self-potential well logging data, resistivity well logging data, neutron well logging data, acoustic well logging data and density well logging data.

Further, the correlation coefficient is calculated by using a Pearson's correlation coefficient computational formula.

The present implementation further provides an electronic device, including a memory, a processor and a computer program stored in the memory and capable of running on the processor, where the processor, when performing the computer program, implements steps of the method for predicting the shear wave time difference.

The present implementation further provides a machine-readable storage medium, where the machine-readable storage medium stores an instruction thereon, and the instruction is used for causing a machine to perform the method for predicting the shear wave time difference.

### Embodiment 1

A training data set is obtained, a well logging sample data set is preprocessed, data screening is performed on the basis of importance analysis, and data is grouped on the basis of kurtosis and the skewness, so as to obtain a preprocessed training data set; a CNN and an LSTM neural network are connected in series through a Dropout layer, so as to form a new neural network structure (a neural network constructed by mixing the CNN and the LSTM), and the processed training data set is respectively inputted into the neural network constructed by mixing the CNN and the LSTM to perform training so as to obtain shear wave time difference prediction model, details of which are as follows:

performing data cleansing, data filtering and normalization on well logging data to obtain first well logging data, so that the data has an accurate and uniform format for convenience of machine learning. “−9999” is a common number in the well logging data and is removed in data cleansing; data filtering is to process the data by using median filtering and filter out a peak hazard; and normalization is to limit the data before 0-1, for conveniently improving a convergence rate and precision of the model.

A correlation of different types of data among the first well logging data to shear wave velocity is obtained and is usually calculated by using a Pearson's correlation coefficient method, it may be obtained that curves most correlated to the shear wave time difference (DTS) (a correlation coefficient is greater than a first preset coefficient value, and in the present implementation, the first preset coefficient value is set to be 0.15) are sequentially DTC, CNL, DEN, GR and RI, DTC, CNL, DEN, GR and RI are used as second well logging data, and a comparison of the correlation coefficient between each data and the shear wave time difference (DTS) is shown in following Table 1:

TABLE 1
Comparison table of correlation coefficients

| | | | | | | | | |
|---|---|---|---|---|---|---|---|---|
| CNL | 1 | 0.99 | 0.81 | 0.81 | 0.52 | 0.17 | 0.11 | −0.18 |
| DEN | 0.99 | 1 | 0.79 | 0.79 | 0.48 | 0.17 | 0.11 | −0.12 |
| DTC | 0.81 | 0.79 | 1 | 1 | 0.5 | 0.15 | 0.1 | −0.42 |
| DTS | 0.81 | 0.79 | 1 | 1 | 0.5 | 0.15 | 0.1 | −0.42 |
| GR | 0.52 | 0.48 | 0.5 | 0.5 | 1 | 0.19 | 0.17 | −0.52 |
| RI | 0.17 | 0.17 | 0.15 | 0.15 | 0.19 | 1 | 0.98 | −0.066 |
| RT | 0.11 | 0.11 | 0.1 | 0.1 | 0.17 | 0.98 | 1 | −0.066 |
| SP | −0.18 | −0.12 | −0.42 | −0.42 | −0.52 | −0.066 | −0.066 | 1 |
| | CNL | DEN | DTC | DTS | GR | RI | RT | SP |

A first column is names of eight inputted curves, which are respectively CNL (compensated neutron log), DEN (bulk density), DTC (compressional wave time difference), DTS (shear wave time difference), GR (gamma ray), RI (shallow resistivity), RT (deep resistivity) and SP (spontaneous potential) from top to bottom, a ninth row is names of eight inputted curves, which are respectively CNL (compensated neutron log), DEN (bulk density), DTC (compressional wave time difference), DTS (shear wave time difference), GR (gamma ray), RI (shallow resistivity), RT (deep resistivity) and SP (spontaneous potential) from left to right, numbers are Pearson's correlation coefficients between the inputted curves, the greater the numerical value is, the higher the correlation is, and the smaller the numerical value is, the lower the correlation is.

If two variables with a great correlation occur in the inputted data at the same time, repeated use of the variables and data redundancy may be caused, thus, the correlation coefficients between five data such as DTC, CNL, DEN, GR and RI are calculated, for example, two data with the correlation coefficient being greater than a second preset coefficient value are obtained: for CNL and DEN. CNL and DEN are used as input variables of the model at the same time, which is equivalent to using “porosity (both CNL and DEN are curves for evaluating porosity)” variable two times, so data redundancy is prone to being caused, and calculation time is prolonged. Therefore, after overall consideration, in the present embodiment, DTC, DEN, GR and RI are selected as third well logging data.

The third well logging data is grouped by using the kurtosis and the skewness as indicators, wells with the kurtosis and the skewness of a compressional wave time difference being greater than 1 in the different wells are in a first group, and wells with the kurtosis and the skewness of a compressional wave time difference being less than 1 in the different wells are in a second group, which are shown in following Table 2:

TABLE 2
Table of grouped data in kurtosis and skewness

| First group | | | Second group | | |
|---|---|---|---|---|---|
| Name | | | Name | | |
| of well | Kurtosis | Skewness | of well | Kurtosis | Skewness |
| A1 | 3.38 | 1.68 | A7 | −0.22 | 0.52 |
| A2 | 2.43 | 1.54 | A8 | −0.76 | 0.02 |
| A3 | 2.83 | 1.66 | A10 | 0.88 | 0.83 |
| A4 | 1.67 | 1.20 | A11 | 0.66 | 0.80 |
| A5 | 2.06 | 1.22 | A12 | −0.32 | 0.49 |
| A9 | 4.75 | 1.81 | A18 | −0.60 | 0.23 |
| A16 | 1.77 | 1.22 | A19 | 0.50 | 0.85 |
| A17 | 1.56 | 1.03 | A20 | 0.27 | 0.59 |

The two groups of well logging data are used as the processed training data set and respectively inputted into the neural network constructed by mixing the CNN and the LSTM for training to obtain a shear wave time difference prediction model.

A21-A24 are a four new wells with shear wave time differences to be predicted, by preprocessing the well logging data, grouping the well logging data on the basis of the kurtosis and the skewness and obtaining the processed well logging data, as an input variable of the shear wave time difference prediction model, the shear wave time difference is predicted, and the steps of preprocessing, and grouping the well logging data on the basis of the kurtosis and the skewness are similar to the above method used when the training data set is processed, which is not described in detail here. Prediction results of the present disclosure, a regional empirical formula and a rock physics modeling method are shown in FIG. 6, and a comparison of prediction precision of different methods is shown in Table 3:

TABLE 3
Comparison table of prediction precision of different methods

| | Intelligent | Empirical | Rock physics |
|---|---|---|---|
| Number | prediction | formula | modeling |
| of well | method | method | method |
| A21 | 93.83% | 90.91% | 92.46% |
| A22 | 94.43% | 91.25% | 93.95% |
| A23 | 94.51% | 91.13% | 91.14% |
| A24 | 95.49% | 92.46% | 90.71% |

In FIG. 6, a first pass is a gamma ray (GR), a spontaneous potential (SP) and a caliper (CALI), the gamma ray and the spontaneous potential represent change of lithology, and the caliper represents good or bad of a borehole. A second pass is a Depth and indicates a distance from a measured well section (namely, a target layer) to a well opening. A third pass is a three-porosity curve, including compressional wave time difference (DTC), bulk density (DEN) and compensated neutron log (CNL) curves and usually used for calculating porosity, which is used for predicting the shear wave time difference here. A fourth pass is a resistivity curve, including deep resistivity (RT), shallow resistivity (RI) and microspherically focused log (MSFL) and usually used for recognizing an oil-gas-water layer, calculating saturability, which is used for predicting the shear wave time difference here. A fifth pass is a shear wave comparison, including the shear wave time difference (DTS) and the intelligent prediction method and used for comparing a shear wave time difference obtained by the intelligent prediction method with an actually measured shear wave time difference. A sixth pass is a shear wave comparison, including the shear wave time difference (DTS) and the empirical formula method and used for comparing a shear wave time difference obtained by the empirical formula method with the actually measured shear wave time difference. A seventh pass is a shear wave comparison, including the shear wave time difference (DTS) and the rock physics modeling method and used for comparing a shear wave time difference obtained by the rock physics modeling method with the actually measured shear wave time difference.

It may be obtained through a comparison in FIG. 6 and Table 3 that the shear wave time difference predicted by the method of the present application has the advantages of higher precision, smaller error and stronger generalization ability than the shear wave time differences obtained by the regional empirical formula and the rock physics modeling method.

Optional implementations of the embodiments of the present disclosure are described in detail above with reference to the accompanying drawings, however, the embodiments of the present disclosure are not limited to the specific details in the above implementations. Various simple variations may be made for the technical solutions of the embodiments of the present disclosure within the scope of the technical concept of the embodiments of the present disclosure, and these simple variations fall within the protection scope of the embodiments of the present disclosure.

It needs to be additionally noted that the various specific technical features described in the above specific implementations may be combined in any suitable mode without contradiction. In order to avoid useless repetitions, various possible combinations are omitted in the embodiments of the present disclosure.

Those skilled in the art may understand that implementation of all or some steps in the method in the above embodiment may be completed by instructing related hardware through a program, and the program is stored in a storage medium and includes a plurality of instructions so as to cause a singlechip microcomputer, a chip or a processor to perform all or some steps in the method of the embodiment of the present application. The above storage medium includes: a USB flash disk, a mobile hard disk drive, a read-only memory (ROM), a random access memory (RAM), a diskette, an optical disc or various media capable of storing a program code.

In addition, various different implementations of the embodiments of the present disclosure may also be combined in any way without violating the concept of the embodiments of the present disclosure, which are also regarded as the contents disclosed by the embodiments of the present disclosure.

1. A method for predicting a shear wave time difference, comprising:
obtaining well logging sample data as a training data set of a prediction model;
performing the following data processing to obtain a processed training data set:
performing data cleansing, data filtering and normalization on the training data set to obtain first training data;
screening out, from the first training data, data with a correlation coefficient between the data and the shear wave time difference being greater than a first preset coefficient value as second training data;
respectively calculating a correlation coefficient between two different types of data in the second training data;
screening out, in a case that two different types of data with the correlation coefficient being greater than a second preset coefficient value exist, any one type of data from the two different types of data, and using the any one type of data and the rest of different types of data with the correlation coefficient being less than or equal to the second preset coefficient value in the second training data as third training data; and
dividing the third training data into at least two groups of well logging data on the basis of a preset kurtosis coefficient and a preset skewness coefficient as the processed training data set;
respectively inputting the processed training data set into a neural network constructed by mixing a CNN and an LSTM for training to obtain a shear wave time difference prediction model;
obtaining well logging data of a shear wave time difference to be predicted;
preprocessing the well logging data, and grouping the well logging data on the basis of the kurtosis and the skewness to obtain processed well logging data; and
respectively using the processed well logging data as an input of the shear wave time difference prediction model to obtain a shear wave time difference.

2. The method according to claim 1, wherein the CNN and the LSTM neural network in the shear wave time difference prediction model are connected through a Dropout layer.

3. The method according to claim 1, wherein the well logging data includes: gamma ray, caliper, spontaneous potential, resistivity, neutron, sonic and density.

4. The method according to claim 1, wherein the correlation coefficient is calculated by using a Pearson's correlation coefficient computational formula.

5. An apparatus for predicting a shear wave time difference, comprising:
a training data obtaining module, configured to obtain well logging sample data as a training data set of a prediction model;
a first data processing module, configured to perform the following data processing to obtain a processed training data set:
performing data cleansing, data filtering and normalization on the training data set to obtain first training data;
screening out, from the first training data, data with a correlation coefficient between the data and the shear wave time difference being greater than a first preset coefficient value as second training data;
respectively calculating a correlation coefficient between two different types of data in the second training data;
screening out, in a case that two different types of data with the correlation coefficient being greater than a second preset coefficient value exist, any one type of data from the two different types of data, and use the any one type of data and the rest of different types of data with the correlation coefficient being less than or equal to the second preset coefficient value in the second training data as third training data; and
dividing the third training data into at least two groups of well logging data on the basis of a preset kurtosis coefficient and a preset skewness coefficient as the processed training data set;
a model training model, configured to respectively input the processed training data set into a neural network constructed by mixing a CNN and an LSTM for training to obtain a shear wave time difference prediction model;
an inputted data obtaining module, configured to obtain well logging data of a shear wave time difference to be predicted;
a second data processing module, configured to preprocess the well logging data, and group the well logging data on the basis of the kurtosis and the skewness to obtain processed well logging data; and
a result output module, configured to respectively use the processed well logging data as an input of the shear wave time difference prediction model to obtain a shear wave time difference.

6. The apparatus according to claim 5, wherein the CNN and the LSTM neural network in the shear wave time difference prediction model are connected through a Dropout layer.

7. The apparatus according to claim 5, wherein the well logging data comprises: gamma ray, caliper, spontaneous potential, resistivity, neutron, sonic and density.

8. The apparatus according to claim 5, wherein the correlation coefficient is calculated by using a Pearson's correlation coefficient computational formula.

9. An electronic device, comprising a memory, a processor and a computer program stored in the memory and capable of running on the processor, wherein the processor, when performing the computer program, implements the following steps:
obtaining well logging sample data as a training data set of a prediction model;
performing the following data processing to obtain a processed training data set:
performing data cleansing, data filtering and normalization on the training data set to obtain first training data;
screening out, from the first training data, data with a correlation coefficient between the data and the shear wave time difference being greater than a first preset coefficient value as second training data;
respectively calculating a correlation coefficient between two different types of data in the second training data;
screening out, in a case that two different types of data with the correlation coefficient being greater than a second preset coefficient value exist, any one type of data from the two different types of data, and using the any one type of data and the rest of different types of data with the correlation coefficient being less than or equal to the second preset coefficient value in the second training data as third training data; and
dividing the third training data into at least two groups of well logging data on the basis of a preset kurtosis coefficient and a preset skewness coefficient as the processed training data set;
respectively inputting the processed training data set into a neural network constructed by mixing a CNN and an LSTM for training to obtain a shear wave time difference prediction model;
obtaining well logging data of a shear wave time difference to be predicted;
preprocessing the well logging data, and grouping the well logging data on the basis of the kurtosis and the skewness to obtain processed well logging data; and
respectively using the processed well logging data as an input of the shear wave time difference prediction model to obtain a shear wave time difference.

10. (canceled)

11. The method according to claim 1, wherein the method is performed by a processor.

12. The method according to claim 1, wherein the obtained shear wave time difference is used for rock physics analysis, lithology identification, rock elastic mechanics parameter calculation, reservoir description and/or fluid identification.

13. The apparatus according to claim 5, wherein the apparatus is implemented as a processor.

14. The apparatus according to claim 5, wherein the obtained shear wave time difference is used for rock physics analysis, lithology identification, rock elastic mechanics parameter calculation, reservoir description and/or fluid identification.

15. The electronic device according to claim 9, wherein the CNN and the LSTM neural network in the shear wave time difference prediction model are connected through a Dropout layer.

16. The electronic device according to claim 9, wherein the well logging data includes: gamma ray, caliper, spontaneous potential, resistivity, neutron, sonic and density.

17. The electronic device according to claim 9, wherein the correlation coefficient is calculated by using a Pearson's correlation coefficient computational formula.

18. The electronic device according to claim 9, wherein the obtained shear wave time difference is used for rock physics analysis, lithology identification, rock elastic mechanics parameter calculation, reservoir description and/or fluid identification.
